(19) United States
(12) Patent Application Publication
(10) Pub. No.: US 2004/0200966 A1
(43) Pub. Date: Oct. 14, 2004

(54) Gamma-ray detection apparatus and method for positron emission tomography

(76) Inventor: David Ramsden, Southampton (GB)

Correspondence Address: Brian M Berliner, O'Melveny & Myers, 400 South Hope Street, Los Angeles, CA, 90071-2899, US

(21) Appl. No.: 10/475,063

(22) PCT Filed: Apr. 18, 2002
(86) PCT No.: PCT/GB02/01804

(30) Foreign Application Priority Data
Apr. 19, 2001 (GB) 0109634.6

(51) Int. Cl. G01T 1/20

(52) U.S. Cl. 250/367

(57) ABSTRACT

A scintillation detector comprising: an array of scintillation crystal elements (22); an array of detection elements (26); and a plurality of light guides (24) connecting each crystal element to multiple ones of the detection elements, so that a scintillation event in any one of the crystal elements gives rise to a signal being generated on a particular combination of the detection elements. This design allows a detection array with a relatively small number of elements, e.g. 61, to be used in conjunction with a scintillation array with a much larger number of elements, e.g. 400. High spatial resolution is thus achievable. Moreover, a high speed digital processor (28) can be used to provide rapid read out of the address of the crystal element where any scintillation event occurred.

### BACKGROUND OF THE INVENTION

The invention relates to scintillation detectors of the type that can be used in positron-emission tomography systems.

Positron-emission tomography (PET) is an imaging technique mainly used as an important new tool in health-care services. PET is used to track the metabolism of pharmaceuticals that have been labelled with a positron-emitting isotope such as ¹⁵O, ¹³N, ¹⁸F.

FIG. 1 schematically, shows the principal features of a PET scanner detection system. The detection system 2 comprises a plurality of gamma-ray scintillation detectors 4 and an associated control and readout electronics system 6. The scintillation detectors 4 are arranged in a plurality of planar rings about, and perpendicular to, a central axis 8. The field-of-view of the system is a volume located around the centre of the ring of detectors. It is noted that in other PET applications, the detectors are not arranged in a ring. For example, in some types of breast screening two planar arrays of detectors are used. The electronics system 6 is connected to the scintillation detectors 4 and determines the timing and location of detection events and provides detector coincidence determination. A patient 10 is positioned along the central axis 8 such that a region of interest within the subject, for example the heart, is within the volume representing the field-of-view of the PET detection system.

A suitable pharmaceutical is selected which allows the study of the biochemical function of the particular organ or tumour type of interest. The pharmaceutical is labelled with a positron-emitting isotope tracer and injected into the patient. A positron emitted from the radioisotope tracer will typically travel only 1-2 mm within the patient before undergoing an electron-positron annihilation event. Two counter propagating 511 keV gamma-ray photons are created at the annihilation site and subsequently detected by the detectors 4. A particular pairing of detectors which coincidently respond to a given annihilation event together define a line along which the event must have occurred. For example, a coincident detection of 511 keV gamma-rays in the detectors marked D₁ and D₂ in FIG. 1 (corresponding to gamma-rays γ₁ and γ₂) indicates that the associated annihilation event occurred somewhere within the patient along the line connecting detectors D₁ and D₂. Furthermore, triangulation based on subsequent coincident detections of 511 keV gamma-rays in the detectors marked D₃ and D₄ (corresponding to gamma-rays γ₃ and γ₄) and D₅ and D₆ (corresponding to gamma-rays γ₅ and γ₆) indicate a relatively high concentration of tracer material at the point marked S in FIG. 1. Improved spatial resolution within the ring of detectors leads to improved volume imaging resolution of the overall PET system and accordingly, each individual detector 4 will itself generally have position sensitivity.

The overall distribution of the positron-emitting tracer is determined by the PET scanner and provides quantitative information on the rate of up-take of the pharmaceutical in the particular region of interest. A full 3-D image of the distribution of the radioisotope may be reconstructed by detecting, simultaneously, the pair of 511 keV gamma-rays produced when a positron annihilates within a millimetre or two of its origin. By identifying the addresses of the two detectors in the ring that surrounds the patient, a line-of-position may be found. By observing many such events, it is possible to reconstruct a 3-D spatial distribution of the labelled pharmaceutical.

The detectability of an object in the field-of-view using a PET system depends primarily on the spatial resolution of the system and the achievable signal-to-noise ratio. The latter, in turn, depends on the number of detected coincidence-events, which is determined by:

The choice of the scintillation crystal and the dimensions of detector array.

The dose given to the patient and the length of the observation period.

The dead-time of the detector system. That is, the time taken to process the information once a valid coincidence has been registered. This is typically 2 μs for the Bismuth Germanate (BGO) block detectors (˜64 locations) and their associated readout electronics that are currently used in most commercial PET systems.

Although the intensity of annihilation photons increases linearly with the dose injected in to the patient, the readout electronics used in current PET systems places an upper limit on the event rate that can be handled. This is one of the major hindrances to the realisation of the full potential of the PET imaging technique. Most commercial PET systems utilise the block detector design [1]. It consists of a segmented single crystal of BGO crystal mounted directly on the faces of four (or two dual-head) photomultiplier (PMT) tubes, or through a light-guide used to couple the crystal array to the PMTs. The address of the crystal, in which the interaction occurred, is determined from information on the way that the scintillation light is shared between those PMT tubes. These detectors usually have a readout-time of around 2 μs per block [2]. When these systems are used in dynamic PET studies that involve the use of relatively short-lived radioisotopes such as ¹⁵O (2.07-minute half-life) and ³N (9.96-minute half-life), severe data-loss may destroy the quantitative reliability of the measured activity in the selected region, as a function of time. Although the loss in count-rate due to the dead-time introduced by that readout system may be recovered partially by applying a correction factor to observed count-rate, such a correction cannot make up for the degradation in the statistical quality of the measurement.

In recent years, this readout dead time has been improved by using a much faster scintillation material such as Lutetium Oxyorthosilicate (LSO) and an improved readout system. A readout time as short as 0.3 μs has been achieved [6].

The MicroPET detector developed by Simon Cherry et al [2], provided an alternative approach to the use of BGO block detectors for small animal PET studies. In this design, an 8×8 array of 2×2×10 mm LSO crystals is readout by a 64-channel photo-multiplier tube (PMT) tube (Philips XP 1722). The scintillation light from each crystal element is routed to a single channel of the multi-channel PMT (MC-PMT) device by a 2 mm diameter fibre light-guide having a length of 25 cm. This design obviates the need to share the scintillation light among several photodetectors. The signals from the MC-PMT are fed into a resistor-chain circuit. It provides four analogue outputs, which are then used to calculate the address of the crystal in which the interaction occurred. This design, although improving the spatial resolution compared with that of the BGO block detectors, has a relatively low sensitivity as a consequence of being restricted to use 10 mm deep crystals due to parallax effects. The readout time for each detector module is better than that of the BGO block detectors.

The ability to rapidly readout a detector module is of great importance for PET applications since the readout time of the detector modules directly determines the rate at which data can be acquired. This is because of the necessity to perform coincidence pairing of scintillation events in different detectors (arranged opposite to each other in the PET detector ring). The nature of PET thus precludes the possibility of allowing signal events to accumulate on the detectors between readouts, as is the case in most other imaging applications. In PET, slow readout rates limit the ability to perform fast dynamic imaging and also result in longer overall integration times for static imaging. The larger doses of radioactive tracer material required for longer integration should be avoided wherever possible since they are harmful to a patient's health. Furthermore, in cases where particularly short-lived isotopes are used, sufficiently long integration times might not be practicable. In these cases, slow readout times inevitably result in poor statistical accuracy and imaging resolution. Accordingly, there is a need in the art for a PET scanner detector system with improved readout rate.

### SUMMARY OF THE INVENTION

According to a first aspect of the invention there is provided a scintillation detector comprising: an array of scintillation crystal elements for absorbing gamma-rays and generating optical signals therefrom; an array of detection elements for detecting the optical signals generated by the scintillation crystal elements; and a plurality of light guides connecting each crystal element to multiple ones of the detection elements, so that a scintillation event in any one of the crystal elements gives rise to a signal being generated on a particular combination of the detection elements.

This design allows a detection array with a relatively small number of elements, e.g. 61, to be used in conjunction with a scintillation array with a much larger number of elements, e.g. 400. High speed digital processing can be used to provide rapid read out of the address of the crystal element where any scintillation event occurred. The task of the digital processing is to identify when signals received simultaneously on the detection elements correspond to one of the particular combinations of detection elements assigned by the light routing paths from the scintillation array to the detection array, and to identify the address, i.e. scintillation crystal, associated with that particular combination. The readout electronics has a high speed analogue front end for pulse shaping and preamplification followed by discrimination. Subsequent to discrimination, the processing is done with high speed digital electronic components which logically decode the received combinations of signals into the crystal element address. For example, a programmable logic array (PLA) or field programmable logic array (FPGA) can be used to provide the decoding logic.

In a preferred embodiment, the array of scintillation crystals is formed by lutetium oxyorthosilicate (LSO). Other scintillation crystal materials could also be used.

The detection elements may be photodiodes. In particular, a preferred embodiment uses a multi-pixel hybrid photodiode for the detection array. Alternatively, a number of photomultipliers may be used, which may be discrete components. For example, 16-20 discrete photomultipliers can be used.

The array of detection elements may advantageously be divided into sub-groups and the light guides are arranged such that all the light guides from any given crystal element are connected to detection elements in the same sub-group. This approach simplifies the readout electronics.

It is also beneficial if the light guides are connected such that none of the light guides from adjacent crystal elements are connected to any of the same detection elements. This reduces the chance of generating simultaneous signals from more than one crystal element routed to the same detection element, as might otherwise oceur for an event in which an incident gamma ray scatters into an adjacent crystal element.

Typically, at least some, if not all, of the detection elements are connected by the light guides to multiple ones of the crystal elements. This follows from the normal implementation of the invention where the number of detection elements is much less, typically by 5-10 times or more, than the number of scintillation crystal elements.

The light guides may be fibre light guides. The fibres may be plastic, glass, polymer or any other suitable material. Moreover, the light guides may be formed from any suitable waveguiding materials, and need not be in any particular form. All that is necessary is that light is routed from the scintillation crystal elements to the detection elements in the desired manner.

In some embodiments, each crystal element is connected by a given number of light guides to the array of detection elements. The given number may be 4, which can be achieved easily with square section scintillation crystal element and circular section light guides arranged in a 2×2 format onto each crystal element. Other square numbers, for example 9, could be achieved with this geometry using a 3×3 format. Other values for the given number could also be used, for example 2, 3, 5, 6, 7 or 8. If crystal elements are rectangular, 2 or 3 light guides may be connected in a line of 1×2 or 1×3, or 8 light guides in a 2×4 format. If the crystal elements are hexagonal, 7 light guides could be connected. Other arrangements may be readily envisaged. In principle, it would also be possible to connect different numbers of light guides to different crystal elements, but this would render the design less elegant.

In typical implementations of the invention it is envisaged that the number of scintillation elements will be in the range 100-1000, the number of light guides 200-4000 and the number of detection elements is 10-200. Implementations outside these ranges are however also possible.

The above described detector may further comprise readout processing electronics with decoding logic associating each particular combination of the detection elements with their connected crystal element. The readout processing electronics is configured to output an address for the crystal element in which each scintillation event originates by applying the decoding logic to the signals received at the detection elements. The decoding logic may be viewed functionally as incorporating a look-up table of associations between each particular combination of detection elements and their connected crystal element. However, in practice, the logic is likely to be implemented directly, for example with a programmable logic array. It is envisaged that the readout processing electronics is embodied with digital electronic components coupled to an optoelectronic-type detection array. In the future, progress in optical processing may allow the readout processor to be implemented with optical logic elements to further improve readout speed in which case the detection array may be optronic rather than optoelectronic. References to readout processing electronics should thus be construed as including optical processing.

According to a second aspect of the invention there is provided a positron-emission tomography (PET) instrument comprising: a plurality of scintillation detectors according to the first aspect of the invention; and an electronics system arranged to receive signals from the scintillation detectors and perform coincidence determination. The detectors may be arranged in rings, or in planar arrays, or in any other configuration suitable for PET.

According to a third aspect of the invention there is provided a gamma-ray detection method comprising: absorbing a gamma-ray in a scintillation crystal element of a scintillation array to generate an optical signal; and routing the optical signal to multiple detection elements of a detector array so that a scintillation event in any one of the crystal elements gives rise to a signal being generated on a particular combination of the detection elements. The method may further comprise applying decoding logic to the signals from the detection elements to generate an address for the crystal element in which each gamma-ray absorption originates.

It will be understood that the scintillation detector described herein has been especially developed for PET applications. However, the scintillation detector may find application in other areas. In particular, the scintillation detector of the invention will be useful whenever fast read out and/or accurate imaging is needed.

### BRIEF DESCRIPTION OF THE DRAWINGS

For a better understanding of the invention and to show how the same may be carried into effect reference is now made by way of example to the accompanying drawings in which:

FIG. 1 shows a schematic perspective view of a generic positron emission tomography (PET) detector system;

FIG. 2 shows a schematic perspective view of a scintillation detector assembly according to an embodiment of the invention;

FIG. 3 shows a schematic view of the scintillation detector assembly shown in FIG. 2 and further details features of the readout electronics and some example light-guide routings;

FIG. 4a shows a schematic plan view of a 61-pixel multi-pixel hybrid photodiode (M-HPD) in which four groupings of 15 pixels have been identified;

FIG. 4b shows a schematic plan view of a scintillator crystal array indicating to which of the pixel grouping shown in FIG. 4a each crystal is optically coupled to;

FIG. 5 shows a scintillation crystal array and encoding fibre light-guide according to another embodiment of the invention;

FIG. 6 is a schematic view of an M-HPD for use with the scintillation crystal array and encoding fibre light-guide shown in FIG. 5 and features of the readout electronics;

FIG. 7 is a graph showing the single-multiple photoelectron response of one pixel of a multi-pixel hybrid photodiode;

FIG. 8 is a schematic diagram showing an experimental determination of the timing resolution of the readout electronics shown in FIG. 6 when coupled to a multi-pixel hybrid photodiode;

FIG. 9 is a graph showing the timing resolution of the readout electronics shown in FIG. 6 coupled to a M-HPD as a function of signal amplitude;

FIG. 10 shows a screen-shot image displaying the signals recorded in each of the 61 pixels of a M-HPD in response to a gamma-ray interaction in a scintillation crystal optically coupled to four of the 61 pixels; and

FIG. 11 is flood illumination map showing the response of the combined detector assembly of FIGS. 5 and 6.

### DETAILED DESCRIPTION

We describe a novel technique that can provide an ultra-fast, high-resolution detector for use in future positron emission tomography (PET) systems. It is based on the use of a Lutetium Oxyorthosilicate (LSO) crystal array readout by a Multi-pixel Hybrid PhotoDiode (M-HPD) using an encoded fibre light-guide. In one example, the fibre encoding method enables one to readout more than 600 discrete crystal elements using a single M-HPD tube having 61 pixels. The key features of the design are the encoded fibre light-guide used in conjunction with a multi-pixel sensor, and the readout electronics which is able to provide, very rapidly, the digital address of the particular crystal in which the gamma-ray was detected. This design eliminates the need for analogue-to-digital converters (ADCs) in finding the address of the crystal in which interaction occurred. The read-out time of a detector comprising around 600 discrete crystals, defined as the time between identifying a valid coincidence signal and the availability of the crystal address can be less than 200 ns. This compares very favourably with the performance of the widely-used block detector which has a dead-time of 2 μs. Whilst this new design offers more than an order of magnitude improvement in readout speed, it is also able to provide a much larger number of possible addresses within that time. As a consequence, one could significantly improve the noise-effective-count-rate (NECR) performance of future PET systems based on the use of this detector design.

This design is similar to the MicroPET detector mentioned above in that the light from individual scintillation crystals is transferred to the photo-detector through plastic fibre light-guides. However, the crystals are viewed through multiple light-guides each routed to a separate large detector pixel at the M-HPD. The identification of say, which four M-HPD pixels detected a signal (typically ˜40 photoelectrons) above a threshold could provide as many as ⁶¹C₄ (521855) separate crystal identifications. In practice, manufacturing constraints will probably lead to some restriction to this large number, typically to less than 1000 crystals.

For example, a practical detector might consist of a 25×25 array of 3×3×30 mm LSO crystals viewed by four 1.5 mm diameter plastic fibres having a length of 35 cm. The scintillation light could be detected by a single 72 mm diameter Multi-pixel Hybrid Photodiode tube (M-HPD) [4] using an encoded fibre light-guide having a length of ˜30 cm. Much longer lengths could be used if desired, for example to separate the photodiodes further from the magnetic field of a magnetic resonance imager. The fibre light-guide is designed to route the scintillation light from each crystal to four different pixels on the M-HPD. By identifying those channels that present a signal above a pre-set threshold value, the address of the crystal hit can be derived rapidly using a simple, fast, logic array. The M-HPD tube envisaged for this use has 61 hexagonal pixels, each having an across-flat dimension of 8 mm. One of the unique features of the M-HPD is that, apart from a signal being available from each individual pixel, it also provides a signal corresponding to the sum of all signals collected on the common side of the anode. In the proposed PET detector design, this common side signal is used to provide a timing signal, and may also be used for energy discrimination in some applications.

Such an arrangement enables one to use a very simple, digital readout method after initial analogue pulse shaping, preamplification and discrimination. The signals from the 61 pixels of the M-HPD tube are readout using two VA32-75 chips [5], which is a 32-channel pre/shaping amplifier array having a CR-RC time-constant of 75 ns. After amplification, the parallel signals are fed into two 32-channel parallel discriminator arrays, TAN, as described in reference [5]. This chip provides 32 identical and independent trigger channels, each with an individually adjustable threshold. By setting appropriate thresholds, those pixels that shared the light from the particular crystal in which the 511 keV photon was detected, can be identified. These trigger outputs from the two TAN chips provide a unique binary word from which the crystal address can be found using a simple, fast logic circuit. This binary digit is then sent into a decoding logic IC which, in turn, provides a 10-bit address for the crystal. By using a high-speed logic IC, the decoding process can be performed within several tens of nanoseconds. Therefore, from a trigger signal being sent from the common side of the M-HPD, the address of the crystal hit can, in principle, be given within a few hundred of nanoseconds.

Compared with the conventional block PET detectors, this design offers a more than an order of magnitude of improvement in readout speed per detector. Such an improvement should significantly improve the noise-effective-count-rate (NECR) performance of the PET systems using this design and greatly reduce the data loss for high count rate, dynamic PET studies.

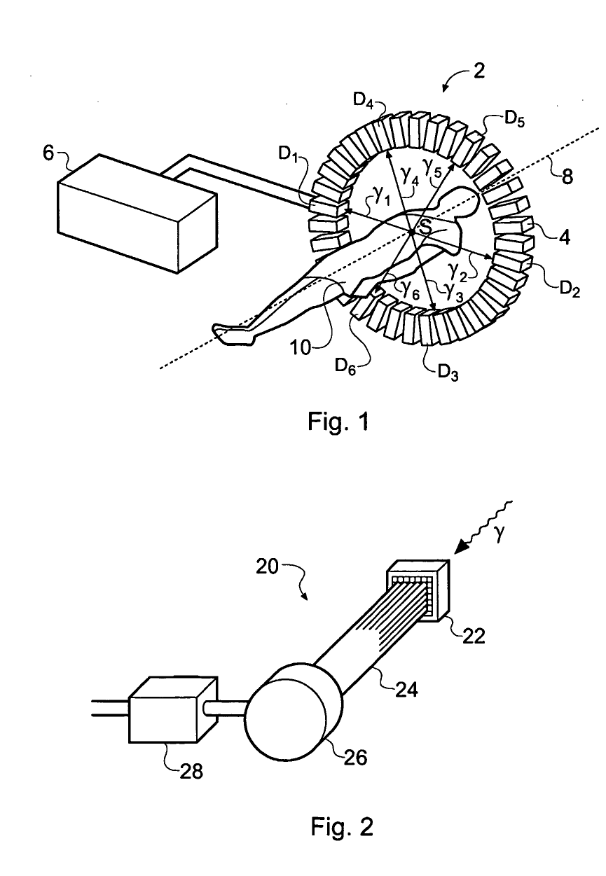

FIG. 2 is a schematic perspective view of an imaging scintillation detector assembly 20 according to a first embodiment of the invention. The detector assembly comprises a scintillation head mounting an array of scintillation crystal elements 22, a bundle of fibre light-guides 24 and a detection array of optical detection elements 26. The output of the optical detection array is connected to a processing unit 28 containing the readout processing electronics and an interface to a PET control system, such as shown in FIG. 1 or a non-ring detector arrangement, e.g. with two planar detector arrays.

The scintillation array 22 comprises 400 LSO crystal elements which are arranged in a 20×20 square array. Discrete scintillation crystals wrapped in PTFE are used for the array. Each crystal element in the scintillation head presents a 2×2 mm square cross-section to an incoming photon γ and is 10 mm deep. A reflective surface treatment is applied to each crystal element to optically isolate the individual elements as discussed further below. The position sensitive optical detector 26 used is a single 72 mm diameter multi-pixel hybrid photodiode tube (M-HPD) [4]. The M-HPD detector has 61 close-packed hexagonal pixels of dimension 8 mm across-flats (A/F) and arranged into four complete rings surrounding a central pixel. Other packing arrangements could be used in alternative embodiments, e.g. square or rectangular. The encoded fibre light-guide bundle 24 contains 1600 plastic fibre light-guides each of 1 mm diameter and 300 mm in length. Four fibre light-guides are coupled to each scintillation crystal element such that the fibre bundle 24 routes the scintillation light from each crystal element in the scintillation head 22 to four different pixels on the M-HPD optical detector 26. In this example, each pixel on the detector will typically be coupled to between twenty-five and thirty-five different scintillation crystal elements. The particular combination of four M-HPD pixels in the optical detector is unique to each scintillation crystal element in the scintillation head. Accordingly, when a gamma-ray photon produces a scintillation event within one of the scintillation crystal elements, the scintillation light is detected by four different pixels in the M-HPD. By identifying the M-HPD channels which record signals above a pre-set threshold value, the address of the crystal in which the interaction occurred can be derived through fully digital simple and fast logic operations in the processing unit 28.

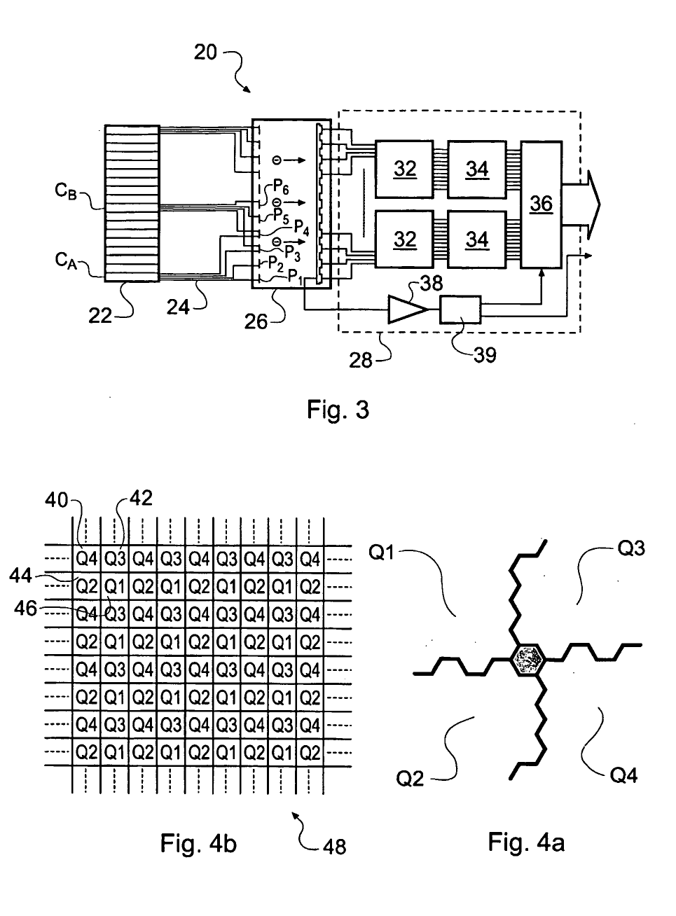

FIG. 3 is a schematic diagram of the scintillation detector assembly 20 shown in FIG. 2 and further details several of the individual fibre connections within the light-guide bundle 24 and some of the components within the readout electronics and interface processing unit 28. The 4-way connections between three of the scintillation crystal elements and their particular unique combination of four M-HPD pixels are schematically indicated. For example, the crystal element marked C_{A} in FIG. 3 is coupled via four fibre light-guides to pixels marked P₁, P₂, P₃ and P₄ and the crystal element marked C_{B} is coupled by four further fibre light-guides to pixels marked P₃, P₄, P₅ and P₆.

The signals from the 61 pixels of the M-HPD detector are read using a multi-channel pre/shaping amplifier array. In this example, two 32-channel Integrated Detector and Electronics AS VA32-75 chips are used in parallel to provide a 64-channel pre/shaping amplifier array having an CR-RC time of 75 ns [5]. After amplification, these signals are fed in parallel into two matching 32-channel Integrated Detector and Electronics AS TAN 32-channel parallel discriminator arrays 34 [5]. Each TAN chip provides 32 identical and independent trigger channels with each trigger channel having an individually adjustable threshold. By setting appropriate thresholds, the four channels sharing light from the scintillation crystal in which the interaction occurred can be identified. The trigger outputs from the two TAN chips directly provide a 64-bit binary word (of which only four of the bits are set) which corresponds uniquely to the crystal element in which the scintillation event occurred. This information is then sent to a decoding logic circuit 36 which provides a 9-bit address for the interaction crystal and presents it to the PET electronics system. In addition to the signal at each pixel, the M-HPD detector also provides a signal corresponding to the sum of all signals on the common side of the anode. This common signal is amplified by an amplifier 38 and passed to a constant fraction discriminator (CFD) 39 to provide a validity and timing signal for the decoding logic circuit 36. The decoding process can be performed within several tens of nanoseconds. Therefore, from the detection of the valid signal at the common side of the M-HPD, the address of the crystal hit can be provided within a few hundred nanoseconds.

Whilst the above example employs four-way encoding for each scintillation crystal element address, it is possible to use any appropriate encoding scheme. As noted above, four-way encoding with a 61-pixel optical detector provides over half-a-million unique addresses. Three-way and two-way encoding of the same 61-pixel detector would provide 35,990 and 1,830 unique addresses respectively. Each of these encoding schemes may be more appropriate for a given scintillation crystal array application. Furthermore, with appropriate decoding logic in the decoding logic circuit it is not necessary that each scintillation crystal element is coupled to the same number of optical detector pixels. Such a scheme can be used to reduce the total number of fibres required or to increase the number of unique addresses achievable with a given optical detector. For example, suppose a 61 -pixel detector is to be used in conjunction with a 1000-element crystal array. A unique address for each crystal can be encoded by a combination of two-way coupling of the scintillation light from 990 of the crystal elements (this can be done uniquely using only 45 of the available 61 detector pixels) and direct one-to-one coupling of the outstanding ten crystal elements to ten of the as-yet unused optical detector pixels. This presents a modest saving of ten fibres over, for example, full two-way encoding of the entire 1000 crystal element array. Similarly, if the aim is to address the maximum number of scintillation crystal elements with a 61-pixel optical detector using no more than two-way encoding, in addition to the 1890 unique addresses provided by two-way encoding to a 61 pixel detector, an additional 61 pixels could be addressed by direct one-to-one coupling. Whilst in general these relatively modest improvements may not outweigh the difficulties associated with, for example, having to set appropriate and different thresholds in different channels, they do provide some scope for expanding the capacity of an encoding scheme which might otherwise fall slightly short of a system's requirements. This expansion can be done without the need to fully realise the next level of encoding which would otherwise have a largely redundant capacity.

However, as indicated above, the capacity of the design will not usually be limited by the encoding scheme, but by the number of fibres or other light guides, that can be practicably coupled to either the crystal elements or optical detector pixels. For example, with the 2×2 mm cross-section crystal elements and the 1 mm plastie fibre light-guides discussed above, there is only space to attach four fibres. Other shapes of crystal element cross-section could also be used. For example, a rectangular crystal element shape could be used in a 1:3 optical routing scheme. Each individual optical detector pixel is coupled to many more fibre light-guides than the individual scintillation crystal elements. Accordingly, even though (unlike the crystal elements) the optical detector pixels can be large without impacting the imaging resolution of the PET system, it will generally be the number of fibres which can practicably be coupled to each detector pixel that limits the design capacity.

The maximum number of uniquely addressable crystal elements that can be readout for some examples of different M-HPD tubes and encoding schemes are listed in Table I. Three detectors are considered, by way of example, two of which are differently sized 61-pixel detectors and one of which is a 127-pixel detector. These detectors are considered in conjunction with five different encoding schemes labelled ^{61/127}C₂, ^{61/112}C₃, ^{61/127}C₄, 4×^{15/32}C₂ and 4×^{15/32}C₄. The first three encoding schemes respectively relate to two-, three- and four-way fibre encoding in conjunction with a 61- or 127-pixel optical detector. The fourth and fifth relate to two- and four-way encoding in conjunction with a 61- or 127-pixel optical detector which has been divided into four distinct sub-groupings of 15 or 32 pixels for the 61- and 127-pixel detectors respectively (with a single pixel remaining unused in each case). For ease of representation, the four sub-groupings of pixels can be spatially linked on the detector, for example being defined by four quadrants surrounding a central unused pixel. However, there are no topological requirements for the physical distribution of the pixels in each sub-grouping on the detector. The number of sub-groupings is preferably equal to, or a fraction of, the number of light guides used per crystal element

Encoding schemes which divide the multi-pixel detector into a number of distinct groups of pixels are preferred since they can reduce effectively the ambiguity in determining the crystal element within which the scintillation event occurred when there is inter-crystal scattering. In particular, four-way encoding schemes are suitable since four fibres which are of roughly appropriate diameter (i.e. 1-mm diameter-fibres for 2×2 mm crystal elements) can effectively collect light from a scintillation event by efficiently covering a large fraction of the associated crystal element's exit window.

TABLE I

| | | No. of | | | | | | |
|---|---|---|---|---|---|---|---|---|
| | | 1 mm | Total | x-tal | x-tal | x-tal | x-tal | x-tal |
| M-HPD | Pixel | fibres per | fibre | capacity | capacity | capacity | capacity | capacity |
| Type | size | pixel | Capacity | ^{61/127}C₂ | ^{61/127}C₃ | ^{61/127}C₄ | 4x^{61/127}C₂ | 4x^{61/127}C₂ |
| Ø40 mm | 4 mm | 10 | 600 | ˜300 | ˜200 | ˜150 | ˜300 | ˜144 |
| 61 pixel | A/F | | | | | | | |
| Ø72 mm | 5 mm | 37 | 2200 | ˜1100 | ˜720 | ˜550 | ˜420 | ˜550 |
| 61 pixel | A/F | | | | | | | |
| Ø72 mm | 5.5 mm | 19 | 2400 | ˜1200 | ˜800 | ˜600 | ˜900 | ˜600 |
| 127 pixel | A/F | | | | | | | |

FIG. 4a schematically shows how the sensitive area of a 61-pixel hybrid photodiode might be divided in to quadrants to provide the four sub-groupings of pixels discussed above. The quadrants are labelled Q1, Q2, Q3 and Q4 as indicated in the figure and each contains 15 pixels. The quadrants are arranged around a central unused pixel. Each crystal element in the scintillation head is associated solely with one quadrant sub-grouping of pixels such that all of the fibre light-guides coupled to a particular crystal element (e.g. four in four-way encoding) are coupled only to detector pixels in that particular quadrant/sub-grouping.

FIG. 4b is a schematic plan view of a portion of a scintillation head 48 for coupling to the detector shown in FIG. 4a. Each square within the head represents an individual scintillation crystal element. The detector quadrant/sub-grouping with which each crystal element is associated is as marked in the figure. For example, the fibre light-guides associated with the crystal element denoted by reference numeral 40 are routed to optical detector pixels within the quadrant marked Q4 shown in FIG. 4a. Similarly, the crystal elements denoted with reference numerals 42, 44 and 46 are associated with detector quadrants Q3, Q2 and Q1 respectively. This pattern of association ensures that all of the light-guides coupled to each particular scintillation crystal element are routed to different detector pixels than those of neighbouring crystal elements. Accordingly, because of the high stopping power of LSO material for crystal elements with cross section greater than around 2×2 mm, there is very little chance of generating a simultaneous signals from more than one crystal routed to the same pixel on the detector as a result of an event in which an incident gamma ray scatters into an adjacent crystal element

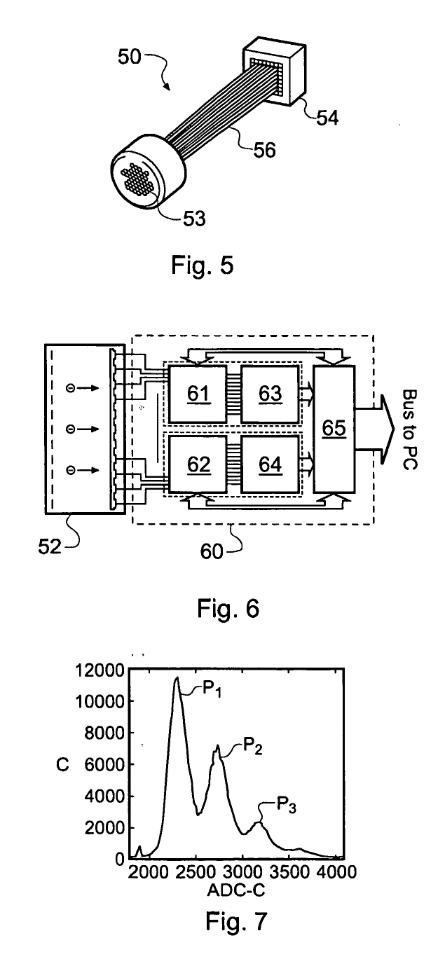

FIG. 5 is a perspective view of a scintillation crystal array and encoding fibre light-guide assembly 50 for a prototype scintillation detector which has been made. A scintillation head 54 is coupled to an optical face plate coupler 53 by an encoding fibre light-guide bundle 56. The scintillation head is a 5×5 array of 2×2×10 mm LSO crystals. The optical face plate coupler 53 maintains the arrangement of the fibres which comprise the encoding fibre light-guide bundle and assists in correctly aligning the fibre bundle with the M-HPD optical detector (not shown). The prototype scintillation crystal array and encoding fibre light guide assembly are designed to couple to an 18-mm 61-pixel M-HPD device. The encoding fibre light-guide is 20 cm long and comprises 100 1-mm plastic fibre light-guides employing the 4×¹⁵C₄ encoding scheme described above.

FIG. 6 schematically shows an M-HPD 52 and associated read out electronics 60 for coupling to the prototype scintillation crystal array and encoding fibre light-guide bundle 50 shown in FIG. 5. The readout electronics are similar to those described above except the VA 32-75/TAN combination is replaced by Integrated Detector and Electronics VA (denoted by reference numerals 61 and 62) and TA (denoted by reference numerals 63 and 64) chips [5] and the function of the decoding logic circuitry is realised by the Integrated Detector and Electronics VA-DAQ system 65 [7]. Some post-processing is carried out by an external computer (not shown). When an interaction occurs in the crystal array, the signals generated in the corresponding channels on the M-HPD are amplified by the associated VA chip and then sent to the relevant TA chip, which hosts an array of discrimination channels. Once one of the channels detects a signal above a preset threshold, the VA-DAQ system 65 generates the logic signals necessary to readout all the channels serially to a computer. The identification of the crystal with interaction will then be performed on the computer by comparing the combination of the channels with triggers with a predefined look-up table.

The results obtained from the prototype detector are now discussed in four sections, namely the performance of the readout electronics, the signal level and energy resolution, the timing resolution and the crystal identification.

### Performance of the Readout Electronics

FIG. 7 is a graph which shows a single and multiple photo-electron spectrum measured by one of the pixels on the 18 mm diameter M-HPD device employed in the prototype detector 50 using a fibre-optic entrance window. The graph plots counts (C) against ADC channel (ADC-C) arbitrarily representing the detected energy in an event. It can be seen from the peaks labelled P₁, P₂ and P₃ in FIG. 7 that the M-HPD detector is able to clearly distinguish between single, double and triple photoelectron events with relatively little noise between the peaks. As described elsewhere [8], the M-HPD device has an unmatched low noise performance. The noise can be kept well below the single photoelectron level, when a high voltage of 10 kV or higher is used. As a result, one can reliably trigger on a signal level as low as a few photoelectrons by setting an appropriate energy threshold on each channel. This makes the M-HPD/VA-TA combination particularly well suited for low-level photon counting applications.

The detector benefits from low cross-talk between the M-HPD pixels. In this prototype detector, the size of the hexagonal M-HPD pixels is 2 mm A/F with a narrow gap of 50 μm separating one pixel from another. To couple a sufficient number of 1-mm diameter fibres to each pixel, the outer fibres on each pixel need to be assembled with very little clearance between them and the pixel boundary. To assist in aligning the optical fibres, the M-HPD 52 employs a 5 mm thick fibre face plate which constrains the light spread effectively. When the fibre bundle is carefully positioned, a cross-talk of less than 10% can be maintained, which, as will be shown below, is sufficient. We also note that in terms of cross-talk, the prototype detector represents a worst-case scenario because the useable space on each pixel is only just adequate for holding these fibres. For example, a 61-pixel 72 mm M-HPD detector having 8 mm A/F pixels can accommodate a bundle of 37 1 mm diameter fibres whilst maintaining a 1 mm gap between the fibres coupled to a particular pixel and the pixel boundary. This arrangement would provide virtually no cross-talk.

### Signal Level and Energy Resolution

The signal level achieved in the prototype detector was measured with coupling between the scintillation head and M-HPD provided by 1 mm diameter, double-clad plastic fibres of different lengths ranging from 10 to 25 cm. These fibre light-guides are supplied by Kuraray and have a numerical aperture of 0.72 [9]. In order to determine the optimum crystal surface treatment, three groups of 2×2×10 mm LSO crystals, with different surface treatments, were tested. One group of LSO crystal elements was polished and polytetrafluoroethylene (PTFE) wrapped, a second group was etched and PTFE wrapped and a third group was polished and silver-coated. It was found that the etched crystals, wrapped by PTFE, gave slightly smaller signals than the polished and PTFE wrapped crystals. The polished and silver-covered crystals, although visually appearing highly reflective and being easy to prepare, provided only around 60% light yield relative to the polished/PTFE ones. Based on these results, the prototype uses etched and PTFE wrapped crystals in the scintillation head as a compromise between moderate light yield and ease of preparation. In some cases different surface finishes may be more appropriate, for example, silver coating of the crystals or simple packing of the voids separating them with a reflective powder, such as magnesium oxide, may be preferred for ease of manufacture. We have experimentally demonstrated that the signal measured by an M-HPD tube with an entrance window made of glass fibre faceplate is only half of that measured using an M-HPD with a quartz entrance window.

Table II summarizes the measured M-HPD signals levels (i.e. typical number of photoelectrons (pe) detected per scintillation event) for the different crystal surface finishes discussed above in conjunction with different lengths of coupling fibre. Each crystal element is coupled to four of the Kuraray fibres described above.

For the prototype detector configuration with each 2×2×10 mm LSO crystal connected to the M-HPD by four 1 mm diameter and 20 cm long fibres, the energy resolution is measured to be ˜30%.

TABLE II

| Crystal surface | 10-cm long | 15-cm long | 20-cm long | 25-cm long |
|---|---|---|---|---|
| finish | fibre | fibre | fibre | fibre |
| Silver coated | 136 pe | 128 pe | 125 pe | 123 pe |
| Etched + PTFE | 217 pe | 205 pe | 199 pe | 196 pe |
| Polished + | 237 pe | 223 pe | 217 pe | 213 pe |
| PTFE | | | | |

The use of the M-HPD tube and VA-TA readout allows the trigger threshold to be set at a level corresponding to around a few photoelectrons on all of the channels. Any signal having an amplitude greater than 10 photoelectrons can trigger the TA chip with near 100% probability. This, compared with the average 40-60 photoelectrons at the end of each fibre for a 511 keV scintillation event, guarantees the accuracy of determining the fibre channels carrying valid signals and the validity of using this information to deduce the address of the crystal element in which the incident gamma ray interaction occurred.

### Timing Resolution

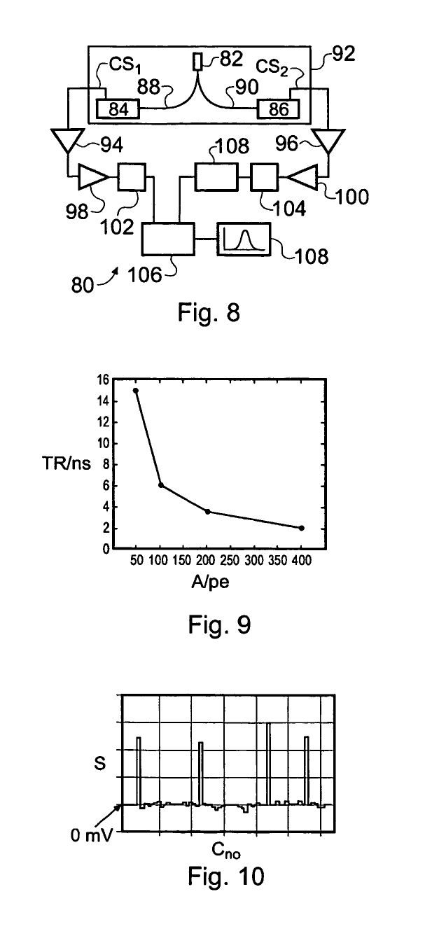

FIG. 8 is a schematic diagram showing an experimental arrangement 80 used to determine the expected time-resolution for a pair of detectors. A light emitting diode light source 82 is coupled to a first M-HPD detector 84 and a second M-HPD detector 86 by first and second fibre light-guides 88, 90 respectively. The light source 82, fibres 88, 90 and M-HPD detectors 84, 86 are enclosed in a light-tight-box 92. The light source is pulsed and produces a flash of light with a decay time of ˜1 microsecond. The common anode signal from the first M-HPD detector 84 (marked CS₁ in FIG. 8) is passed to a Eurorad PR16 pre-amplifier 94. The output of the pre-amplifier is passed to a Eurorad SH1 shaper 98 and subsequently to an EG&G 584 constant fraction discriminator (CFD) 102. The output of the CFD is used to start a timer circuit 106. The common anode signal from the second M-HPD 86 (marked CS₂ in FIG. 8) is similarly passed to a pre-amplifier 96, shaper 100 and a CFD 104. However, the output of the CFD associated with the second M-HPD 86 is then delayed for a fixed time in a delay circuit 108 before being used to stop the timer circuit 106. The time between the stop and start signals for is recorded and the timer circuit reset between pulses. The individual time differences between start and stop signals to the timer circuit 106 are recorded for a large number of pulses and a histogram 108 plotted to show the frequency distribution of events as a function of start-stop time difference. The histogram distribution is centred on the fixed delay set by the delay unit 108 with a full-width at half-maximum which represents the system's timing resolution.

Whilst this measurement was made using an LED light source rather than direct scintillation light, we believe that our results correspond to a worst-case scenario since the scintillation light output from LSO crystal has been shown to rise to a maximum within a few ns [10] and decay with an exponential time constant of only 40 ns. This is much shorter than the decay time of the pulsed LED output used in the experiment.

FIG. 9 is a graph showing the timing resolution TR in nano-seconds as function of signal amplitude A in photoelectrons (the two M-HPD detectors are arranged to each receive comparable signal amplitudes). For signal levels of >200 photoelectrons for each 511 keV deposited in the crystal array such as seen above, a coincidence timing resolution of less than 4 ns may be expected.

### Crystal Identification

As described above, the detector relies on a unique technique for finding the crystals in which interaction occurred. Any combination of four or more channels having signal level above a certain threshold that matches an entry in a predefined look-up table, would provide one or more addresses of the crystals hit by an incident gamma ray.

FIG. 7 is an image showing a screen shot taken from the VA-DAQ user interface. The image shows signal amplitude S as a function of channel number Cₙₒ. The channel number ranges from 0 to 63 with 61 channels corresponding to the signal seen each pixel on the 61-pixel M-HPD. FIG. 7 shows that the scintillation light from the particular 2×2×10 mm LSO crystal hit is shared fairly equally between the four 1 mm fibre optics to which it is coupled, which results in four VA channels with signal levels of between 40 to 60 photoelectrons. This figure also demonstrated that by correctly aligning the fibre bundle with the M-HPD pixels, very little cross-talk occurs with very little signal seen in the remaining channels.

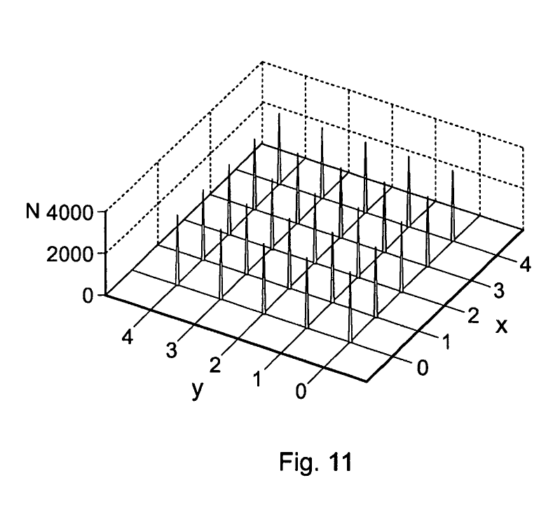

FIG. 11 is a 3 dimensional plot showing a typical flood illumination map produced by placing a ²²Na point source 10 cm away from the prototype detector and the information from detected events sent to a computer for further processing. FIG. 11 plots the number of events N addressed to each scintillator crystal element as a function of each elements position in the 5×5 array. The position of each crystal element is defined in a simple XY Cartesian co-ordinate system The crystals in which interactions occurred were determined using a look-up table describing the particular encoding scheme used. Unlike normal PET detectors, this flood illumination map shows the reconstructed interaction locations with a series of sharp delta-function like profiles. In making this map, those events involving inter-crystal scattering were also included using the logic described above.

### Conclusions and Discussion

We have described a novel PET detector design based on the use of a large-area M-HPD tube and VA32-75/TAN chips. In this detector, the process of determining the crystal in which interaction occurred is completely independent of extracting the energy and timing information. Moreover, the design has several other advantages as listed below:

By using a fibre encoding method, as many as 500 to 1000 crystals having a cross-section of 2×2 mm can be readout by a single 72-mm diameter, M-HPD tube and 61 electronics channels. Since the crystal addresses are extracted digitally, no ADC is required in the readout system. This greatly reduces the cost and complexity of the readout electronics.

This much simplified readout electronics is also capable of providing an ultra fast readout speed. For example, once a coincidence is identified, a 25×25 array of 2×2×10 mm crystals can be readout in less than 100 ns. In comparison, a readout time of >300 ns is normally required in commercial PET detectors with having 64 crystals. Clearly, this improvement in readout speed would result in a much higher NECR performance for PET system based on the proposed detector design.

A prototype based on a 5×5 array of 2×2×10 mm LSO crystals has demonstrated that such a detector design is capable of providing good timing, energy and spatial resolutions for PET applications.

### REFERENCES

[1] M E Casey and R Nutt, “A multicrystal two dimensional BGO detector system for positron emission tomography”, IEEE NS33, p460, 1986.

[2] Lars-Eric Adam et al, “Performance evaluation of the whole-body PET scanner ECAT EXACT HR+following the IEC standard”, IEEE NS44, p1172, 1997.

[3] Y Shao et al, “Development of a PET detector system compatible with MRI/NMR system”, IEEE NS44, p1167, 1997.

[4] DeSalvo R. “Why people like the Hybrid Photodiode”. Nuclear Instruments and Methods in Physics Research A387, pp.92-96, 1997.

[5] IDEAS Catalog. IDEAS ASA, Norway, http://www.ideas.no

[6] W. W. Moses, P. R. G. Virador, S. E. Derenzo, R. H. Huesman, T. F. Budinger, “Design of a High-resolution, High sensitivity PET Camera for Human Brains and small animals”, IEEE Trans. Nucl. Sci. 44, p1487, 1997.

[7] VA-DAQ User Manual, IDEAS ASA, Norway.

[8] C. P. Datema, L. J. Meng and D. Ramsden, “Results obtained using a 61 pixel Multi-pixel Hybrid Photodiode Scintillation Camera”, Nuclear Instruments and Methods in Physics Research Section A- Accelerator Spectrometers Detectors and Associated Equipment, 1999, Vol.422, No.1-3, pp.656-660.

[9] Product Catalogue, Kuraray Co Ltd.

[10] H. Suzuki and T. A. Topmbrello, “Light emission mechanism of Lu2(SiO4):Ce”, IEEE Transactions on Nuclear Science, 1993, Vol.40, pp.380-383.).

[11] C. D'Ambrosio, F. De Notaristefani, T. Gys, H. Leutz, D. Piedigrossi, D. Puertolas, E. Rosso, “Recent Developments on ISPA-cameras for gamma ray imaging: gamma imaging with an electrostatic crossed focused ISPA-tube”

1. A scintillation detector comprising:
an array of scintillation crystal elements (22) for absorbing gamma-rays and generating optical signals therefrom;
an array of detection elements (26) for detecting the optical signals generated by the scintillation crystal elements; and
a plurality of light guides (24) connecting each crystal element to multiple ones of the detection elements, so that a scintillation event in any one of the crystal elements gives rise to a signal being generated on a particular combination of the detection elements.

2. A detector according to claim 1, wherein the array of scintillation crystals is formed by lutetium oxyorthosilicate.

3. A detector according to claim 1 or 2, wherein the detection elements are photodiodes.

4. A detector according to claim 1 or 2, wherein the array of detection elements is formed by a multi-pixel hybrid photodiode.

5. A detector according to claim 1 or 2, wherein the detection elements are photomultipliers.

6. A detector according to any one of the preceding claims, wherein the array of detection elements is divided into sub-groups and the light guides are arranged such that all the light guides from any given crystal element are connected to detection elements in the same sub-group.

7. A detector according to any one of the preceding claims, wherein none of the light guides from adjacent crystal elements are connected to any of the same detection elements.

8. A detector according to any one of the preceding claims, wherein at least some of the detection elements are connected by the light guides to multiple ones of the crystal elements.

9. A detector according to any one of the preceding claims, wherein the light guides are fibre light guides.

10. A detector according to any one of the preceding claims, wherein each crystal element is connected by a given number of light guides to the array of detection elements.

11. A detector according to claim 10, wherein the given number is 4.

12. A detector according to claim 10, wherein the given number is 2, 3, 5, 6, 7 or 8.

13. A detector according to any one of the preceding claims, further comprising:
readout processing electronics (28) with decoding logic associating each particular combination of the detection elements with their connected crystal element, the readout processing electronics being configured to output an address for the crystal element in which each scintillation event originates by applying the decoding logic to the signals received at the detection elements.

14. A positron-emission tomography (PET) instrument comprising:
a plurality of scintillation detectors according to any one of the preceding claims; and
an electronics system arranged to receive signals from the scintillation detectors and perform coincidence determination.

15. A gamma-ray detection method comprising:
absorbing a gamma-ray in a scintillation crystal element of a scintillation array to generate an optical signal; and
routing the optical signal to multiple detection elements of a detector array so that a scintillation event in any one of the crystal elements gives rise to a signal being generated on a particular combination of the detection elements.

16. The method of claim 15, further comprising applying decoding logic to the signals from the detection elements to generate an address for the crystal element in which each gamma-ray absorption originates.
